(19) United States
(12) Patent Application Publication
(10) Pub. No.: US 2017/0117681 A1
(43) Pub. Date: Apr. 27, 2017

(54) SOLID-STATE LASER

(71) Applicant: Daniel KOPF, Rothis (AT)

(72) Inventor: Daniel KOPF, Rothis (AT)

(21) Appl. No.: 15/126,017

(22) PCT Filed: Mar. 10, 2015
(86) PCT No.: PCT/AT2015/000038

§ 371 Date: Sep. 14, 2016

(30) Foreign Application Priority Data
Mar. 14, 2014 (AT) A 184/2014

(51) Int. Cl. H01S 3/0941; H01S 3/16; H01S 3/042; H01S 3/08; H01S 3/04; H01S 3/06

(52) U.S. Cl. CPC H01S 3/0941; H01S 3/0405; H01S 3/0606; H01S 3/042; H01S 3/08072; H01S 3/08095; H01S 3/1611; H01S 3/1643

(57) ABSTRACT

A solid-state laser has an amplifying laser medium for producing a laser beam and a pump device that has at least one laser diode and that produces a pump radiation that impinges on a first side face of the laser medium, which side face is parallel to a z axis and parallel to a y axis that is at right angles to the z axis. On a second side face, which is opposite the first side face, the laser medium is cooled by a heat sink. The length of a y−1/e2 region of the pump radiation is shorter than the length of the first side face of the laser medium in the direction of the y axis, wherein the y−1/e2 region of the pump radiation denotes a section of the y axis over which the intensity of the pump radiation on the first side face of the laser medium has a value that is more than the maximum intensity of the pump radiation on the first side face of the laser medium divided by e2. The length of a y cooling region, which length denotes a section of the y axis, over which a cooling strip extends is less than 70% and greater than 50% of the length of a y pump region of the laser medium, wherein the y pump region denotes a section of the y axis over which 80% of the total power of the pump radiation that is absorbed by the laser medium is absorbed and at the two ends of which the intensity of the pump radiation is of equal magnitude.

### FIELD OF THE INVENTION

The invention relates to a solid-state laser having an amplifying laser medium for producing a laser beam and a pump device which has at least one laser diode and by which pump radiation is produced, said pump radiation impinges on a first side face of the laser medium, which side face is parallel to a z axis and parallel to a y axis which is at a right angle to the z axis, wherein, viewed in a direction of an x axis which is at a right angle to the z axis and at a right angle to the y axis, the laser beam runs through the laser medium parallel to the z axis, wherein the laser medium is cooled by a heat sink on a second side face which is parallel to the z axis and parallel to the y axis and opposite the first side face, said laser medium being thermally connected to said heat sink, wherein the length of a y cooling region is shorter than the length of the second side face of the laser medium in the direction of the y axis, wherein the y cooling region of the laser medium denotes a section of the y axis over which a cooling strip extends, by means of which cooling strip the laser medium is thermally connected to the heat sink at the second side face, wherein the length of a y−1/e² region of the pump radiation is shorter than the length of the first side face of the laser medium in the direction of the y axis, and the first side face of the laser medium extends beyond the y−1/e² region of the pump radiation in both directions of the y axis, wherein the y−1/e²region of the pump radiation denotes a section of the y axis over which the intensity of the pump radiation at the first side face of the laser medium has a value which is more than the maximum intensity of the pump radiation at the first side face of the laser medium divided by e².

### BACKGROUND

Laterally pumped solid-state lasers, in particular those with a zig-zag geometry (=lasers with “zig-zag slab gain medium”) are widespread. Nd:YAG is the best known laser medium for nano-second lasers due to the relatively high gain, a storage time of 250 μs and the availability in large slabs (>10 cm) at comparatively low cost. In addition to Nd:YAG, inter alia Nd:Glass, Nd:VANADAT or Yb:YAG are known as amplifying laser media (=laser-active materials).

In order to pump solid-state lasers, recently laser diodes have been increasingly used instead of flash lamps. A solid-state laser which is pumped in this way is described, for example, in Errico Armandillo and Callum Norrie: “Diode-pumped high-efficiency high-brightness Q-switched ND:YAG slab laser”, OPTICS LETTERS, vol. 22, no. 15, Aug. 1, 1997, pages 1168 to 1170. Laser diodes have, in particular, advantages in terms of the efficiency, the pumping efficiency and the service life. In order to achieve relatively high pumping powers, a plurality of laser diodes are combined in one common component. In the case of bars, a plurality of laser diodes (=individual emitters) are arranged on a strip-shaped chip and operated electrically in parallel and mounted on a common heat sink. The individual emitters of such a bar each emit a laser beam which has a significantly larger emission angle, e.g. +/−33° in the direction of what is referred to as a fast axis than in a direction of what is referred to as a slow axis which is at a right angle thereto and in which direction the emission angle is e.g. +/−5°. In the case of laser diode stacks, a plurality of such bars are arranged one next to the other with their broadsides and/or narrow sides. Different types of optical systems have been used for feeding the highly divergent laser radiation emitted by such a laser diode stack to the amplifying laser medium in a correspondingly focused way. For example, it is known to arrange a microlens in the form of a cylinder lens in front of the laser diodes of a respective bar, wherein the cylinder axes are oriented in the direction of the slow axis, with the result that the strong divergence in the direction of the fast axis is reduced, e.g. to less than 1°. As a result, the subsequent optics for imaging the laser radiation in the amplifying laser medium are significantly simplified.

WO 2014/019003 A1 discloses using a common cylindrical mirror whose cylinder axis is oriented in the direction of the fast axis and which focuses the light of all the laser diodes in the direction of the slow axis, or to use such a cylinder lens. It is possible here to achieve a high pumping efficiency with a compact design.

Other different optical systems for focusing the light emitted by laser diode bars, e.g. for pumping solid-state lasers, are known, for example, from U.S. 2011/0064112 A1, U.S. 2007/0064754 A1 or JP P2004-96092 A.

A problem with solid-state lasers are thermal effects which lead to the formation of thermal lenses and/or to the generation of stress-induced birefringence. For example, Nd:YAG exhibits relatively strong thermal effects of this kind. The stress-induced birefringence generates, in particular in the radially symmetrical pump geometries, e.g. in the case of the laser medium being embodied in the form of a cylindrical rod, polarization rotation of parts of the beam profile and also to a loss of a polarizing element in the resonator, which can lead to a significant loss in the case of active Q switching with electro-optical elements (Pockels cells). This effect of stress-induced birefringence is minimized or almost not present in a zigzag slab laser. The formation of a thermal lens can also be minimized in a zigzag slab laser in the plane of the zigzag-shaped profile of the laser beam (x-z plane) but a non-diminishing positive thermal lens is produced in the direction perpendicular thereto (the direction of the y axis). As a result, it is necessary to install compensatory optics which then have a compensating effect only for a specific power range. In the case of an Nd:YAG laser this is already necessary starting from approximately 1 watt of conventional output power, depending on how stringent the requirements of beam geometry and beam astigmatism are.

A solid-state laser of the type mentioned at the beginning can be found in Donald B. Coyle et al.: “Efficient, reliable, long-lifetime, diode-pumped Nd:YAG laser for space-based vegetation topographical altimetry”, APPLIED OPTICS, vol. 43, No. 27, Sep. 20, 2004, pages 5236-5242. The laser medium, which is embodied in the form of a slab, that is to say in a prismatic shape, has a longitudinal axis which extends in the direction of a z axis and has side faces which are parallel to x and y axes which are at a right angle to one another and at a right angle to the z axis. The laser beam passes through the laser medium in a zig-zag shape in the x-z plane. The pumping by means of laser diodes is carried out by means of a first side face which is parallel to the y axis and parallel to the z axis, and the laser medium is cooled on the second side face which is located opposite and is parallel to the first side face. In order to achieve a more uniform temperature distribution in the laser medium, as a result of which the thermal lens can also be reduced with respect to the y direction, the cooling does not take place over the entire extent of the second side face in the direction of the y axis but instead only over a strip with a width, reduced with respect thereto, in the direction of the y axis. This is achieved by means of a step in the heat sink which rests on the second side face. However, a thermal lens, albeit a reduced one, is still formed, and said thermal lens is compensated by the use of a negative cylindrical lens in the resonator.

The pump radiation which impinges on the first side face has an essentially Gaussian profile in the case of this laser. If the two points are considered at which the intensity of the pump radiation has dropped to a value of 1/e² of the maximum intensity with respect to the y axis, the length of this y−1/²region of the pump radiation is shorter than the length of the first side face of the laser medium in the direction of the y axis. The laser medium is therefore not pumped essentially uniformly as far as its edge with respect to the y direction but rather only in a more or less central region. As a result, the limited extent of the laser medium in the y direction does not act as an aperture for the laser radiation. If, in contrast, the laser medium were to be pumped over its entire extent in the y direction, the formation of a thermal lens in the y direction could be substantially avoided but the aperture then brought about by the laser medium in the y direction would have negative effects on the quality of the laser beam emitted by the solid-state laser.

### SUMMARY

The object of the invention is to make available an improved solid-state laser of the type mentioned at the beginning. This is achieved by means of a solid-state laser having one or more features of the invention.

In the case of the solid-state laser according to the invention, the length of a y cooling region of the laser medium is shorter than 70% and larger than 50% of the length of the y pump region of the laser medium, wherein the y pump region exceeds the y cooling region in both directions of the y axis. As already mentioned in the introduction, the y cooling region of the laser medium denotes a section of the y axis over which a cooling strip extends, by means of which the laser medium is connected to the heat sink. The y pump region of the laser medium denotes a section of the y axis over which 80% of the total power of the pump radiation absorbed by the laser medium is absorbed, and at the two ends of which the intensity of the pump radiation is of equal magnitude. The majority of the heat is therefore introduced into the laser medium via the y pump region.

It has been found that with such a formation of a solid-state laser a thermal lens in the y direction can be at least largely or even completely avoided. This can be explained by a central depression in the temperature distribution, as will be explained in more detail below. In particular, this is achieved with a beam profile of the pump radiation which tends to extend in the direction of a rectangular beam profile rather than in the direction of a Gaussian profile.

The fact that the profile of the pump radiation tends to be rectangular rather than Gaussian means that in the case of the solid-state laser according to the invention the difference between the length of the y−1/e² region of the pump radiation and the length of a y half value region of the pump radiation is advantageously less than half as large as the difference between the length of a y−1/e² region and the length of a y half value region of a virtual beam with the same wavelength, which virtual beam has a Gaussian profile and the length of a y half value region of which is equal to the length of the y half value region of the pump radiation and the radiation energy of which is equal to the radiation energy of the pump radiation. As already mentioned in the introduction, the y−1/e² region of the pump radiation denotes a section of the y axis over which the intensity of the pump radiation at the first side face of the laser medium has a value which is more than the maximum intensity of the pump radiation at the first side face of the laser medium divided by e², that is to say is more than approximately 13.5%. The y half value region of the pump radiation denotes a section of the y axis over which the intensity of the pump radiation at the first side face of the laser medium has a value which is more than half the maximum intensity of the pump radiation at the first side face of the laser medium. The y−1/e² region and the y half value region of the virtual beam having a Gaussian profile are defined analogously.

This means therefore that the pump radiation declines to a significantly larger extent at the edge than is the case with a Gaussian profile. The pump radiation is therefore approximated more to a rectangular profile compared to a Gaussian profile.

In particular, according to the invention it is possible to form an advantageous solid-state laser in which the laser beam (=the laser mode) runs in a zig-zag shape through the laser medium, specifically in a plane at a right angle to the y axis.

It is therefore possible to make available, for example, a laser which emits an essentially symmetrical beam in a power range from 0 to more than 5 W average power. In particular, a beam with a beam divergence of <250 μrad (half-angle divergence) in both transverse directions and a quality factor M [symbol] 2 of <5, preferably <3, can be achieved over the entire power range.

With the invention it is also possible, for example, to make available a pulsed solid-state laser, in particular Nd:YAG zigzag laser with >50 mJ energy and a beam with a small beam divergence (e.g. <250 μrad half-angle divergence) and good beam quality (e.g. M [symbol] 2<5 or <3) which satisfies the tightly defined beam parameters independently of the repetition rate, that is to say e.g. both in the case of single pulse operation (single shot) and in the case of 50 Hz or 100 Hz (corresponding to 5 W average power).

### BRIEF DESCRIPTION OF THE DRAWINGS

Further advantages and details of the invention are explained below with reference to the appended drawing, in which:

FIG. 1 shows a highly schematic illustration of an exemplary embodiment of a laser according to the invention;

FIG. 2 shows an oblique view of the pump device and of the laser medium as well as of the heat sink in relatively large detail;

FIG. 3 shows an oblique view of the radiation source of the pump device;

FIG. 4 shows a section through the laser medium and part of the pump device and of the heat sink in the y-x plane (sectional line AA in FIG. 5);

FIG. 5 shows a side view of the laser medium and of part of the heat sink and of the pump device in the direction of the y axis (viewing direction B in FIG. 4);

FIG. 6 shows a side view of the laser medium, of the pumped first side face in the direction of the x axis (viewing direction C in FIG. 4), wherein a “pumped region” is indicated by hatching and the cooling strip resting on the second side face which is located opposite is represented by dashed lines;

FIG. 7 shows a diagram comparing the intensity distribution of the pump radiation on the first side face of the laser medium with respect to the y direction with the intensity distribution of a virtual beam with a Gaussian profile; and

FIG. 8 shows a diagram in which the refractive index D of the thermal lens which is formed is represented as a function of the length of the y cooling region with respect to the y direction.

### DETAILED DESCRIPTION OF THE PREFERRED EMBODIMENTS

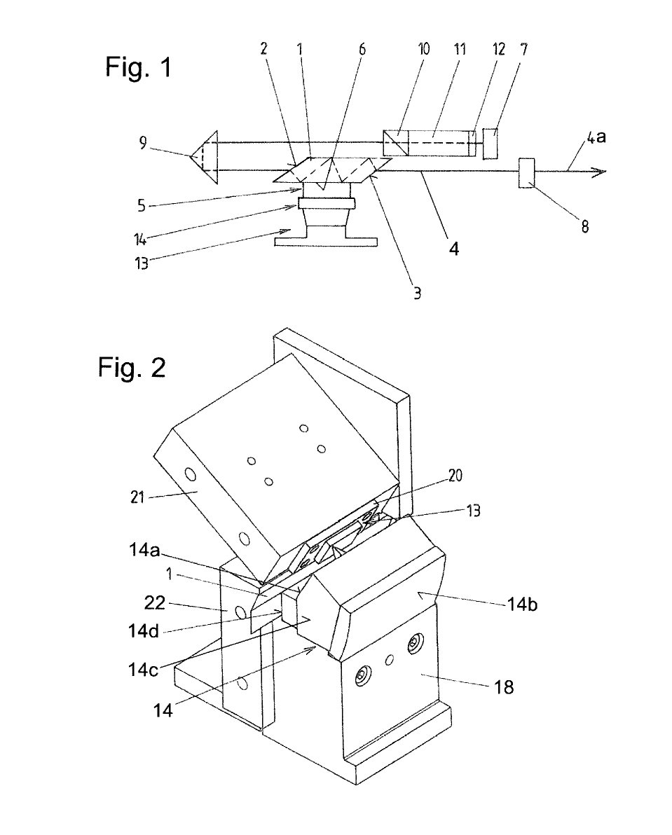

One possible embodiment of a solid-state laser according to the invention is illustrated schematically in FIG. 1. The embodiment is a solid-state laser whose amplifying (active) laser medium 1 is composed of a crystalline or glass-like (amorphous) solid body. For example, the amplifying laser medium can be Nd:YAG, Nd:Glass, Nd:Vanadat, Yb:YAG, Er: YAG or Ho: YAG.

The amplifying laser medium 1, which can also be referred to as laser-active material, is arranged in a resonator whose components will be explained in more detail below.

The amplifying laser medium 1 is a prismatic design, that is to say it is a slab laser. Although the laser beam 4 in FIG. 1 which is formed by the emission of the amplifying laser medium 1 is illustrated running in a zigzag shape through the amplifying laser medium 1, it could also run linearly through it. The entry and exit faces 2, 3 for the laser beam 4 which is emitted by the laser medium 1 and passes through the resonator are advantageously arranged in the Brewster angle, which is however not absolutely necessary.

The amplifying laser medium 1 is laterally pumped, as is known. The pump radiation 5 which pumps the amplifying laser medium 1 is therefore not incident in the laser medium through the entry and exit faces 2, 3 but rather through a first side face 6. This side face 6 is at an angle to the entry and exit faces 2, 3. In particular, the pump radiation 5 impinges essentially centrally on the first side face 6.

The resonator comprises an end mirror 7 and an output coupling mirror 8 in order to output the laser beam 4a which is emitted by the laser. The resonator which is illustrated is folded once, for which purpose an inverting prism 9 is arranged in the beam path. The folding could also be dispensed with or the resonator could be folded repeatedly. Other folding mirrors could also be provided.

In order to form a Q switch, a polarizer 10, a Pockels cell 11 and a λ/4 plate are arranged in the beam path of the resonator in the exemplary embodiment illustrated. The laser beam 4a which is emitted by the laser is therefore pulsed. In order to form pulses, Q switches other than electro-optical Q switches, in particular acousto-optical Q switches could also be provided.

A mirror arranged in the beam path, in particular the output coupling mirror 8 or the end mirror 7 is preferably embodied, as is known, as a gradient mirror whose reflectivity changes over the surface of the mirror and in this context is higher in a central region than in an edge region. As a result, the beam profile of the laser beam can be influenced, for example in order to achieve a more rapid decline in the intensity at the edge, and/or the beam quality of the laser beam can be improved.

The pumping of the amplifying laser medium is carried out by a pump device which has a radiation source 13 which comprises a plurality of laser diodes The optical system 14 of the pump device for advantageously feeding the amplifying laser medium 1 with the laser radiation which is output by the radiation source 13 is indicated only schematically in FIG. 1.

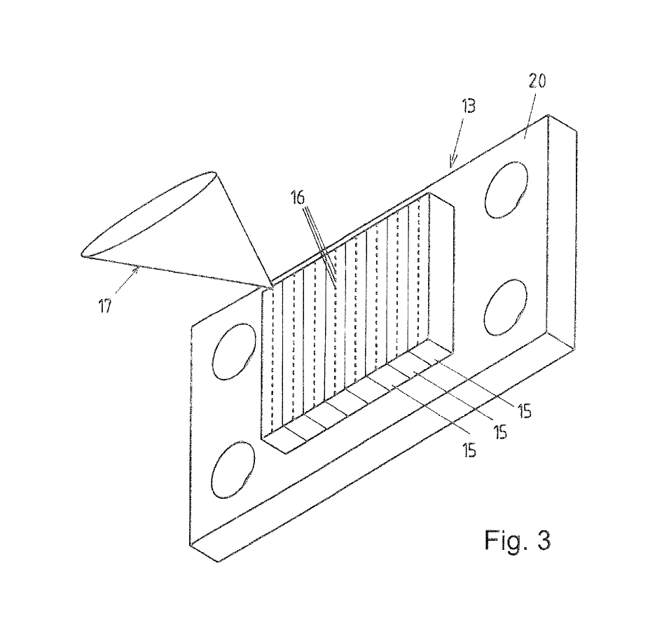

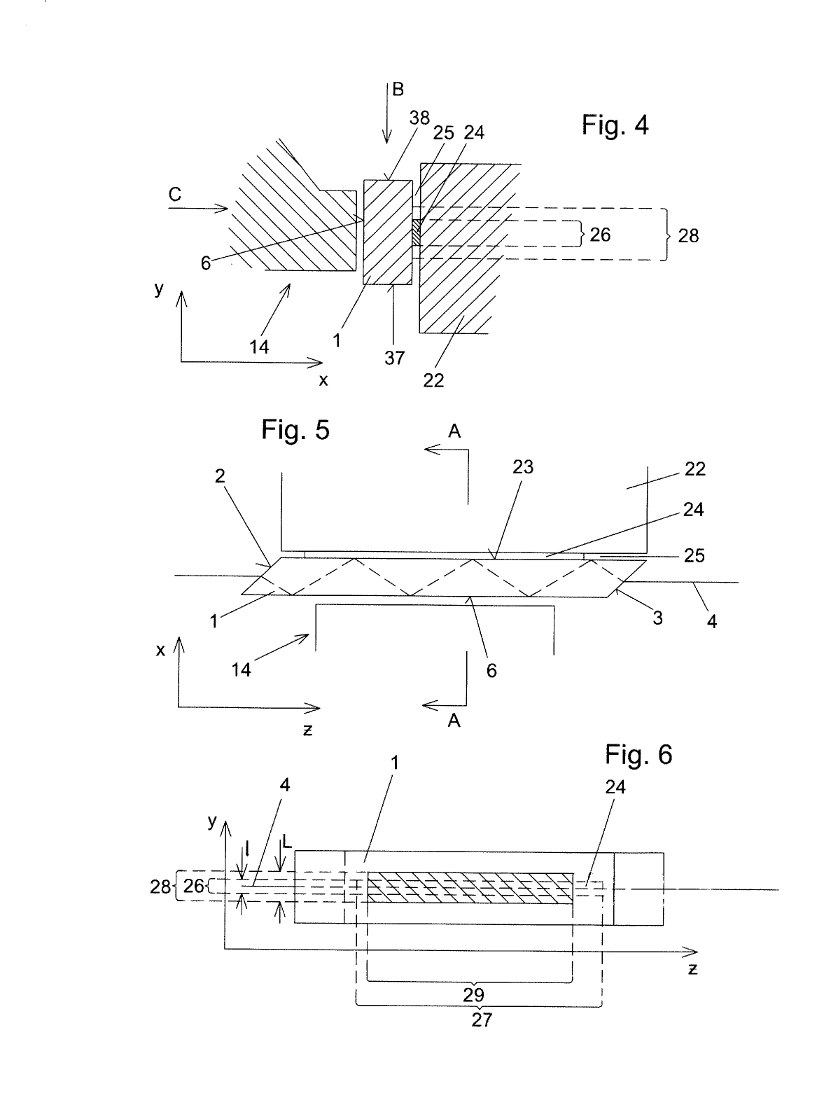

The radiation source 13 is preferably embodied in the form of a laser diode stack, and an example of this is illustrated in FIG. 3. The laser diode stack comprises a plurality of bars 15 which are arranged one next the other and each have a plurality of laser diodes 16 spaced apart in one direction.

The beams 17 emitted by the laser diodes 16 have a more than three times as large divergence in the direction of an axis which is at a right angle to the beam axis of the respective beam 17 and referred to as fast axis as in the direction of an axis which is at a right angle to the beam axis and at a right angle to the fast axis and is referred to as a slow axis. For example, the emission angle (=the divergence) with respect to the fast axis can be +/−33° (that is to say 66° angle of aperture of the radiation cone) and the emission angle can be +/−5° with respect to the slow axis.

The bars 15 are secured to the carrier 20, cf. FIG. 2, which is mounted on a heat sink 21 which is, for example, water cooled.

The optical system 14 of the pump device is formed in the exemplary embodiment by an optical component which has a reflective cylinder face 14b on which the beams which are output by the laser diodes 17 of the radiation source and enter the optical component through the entry face 14a are reflected. This cylinder face 14b has here a collecting effect with respect to the slow axis. The divergence of the beams 17 with respect to the fast axis is maintained, and there is merely a reflection or a plurality of reflections at side faces 14c of the optical component in order to limit the range of the radiation in this direction.

The optical component which forms the optical system 14 of the pump device can be formed, for example as illustrated in FIG. 2, from a plurality of parts which are connected to one another by bonding and are composed of a transparent material. The optical component is attached to a carrier 18.

The radiation which is output by the pump device as pump radiation arrives at the first side face 6 of the laser medium 1 through the exit face 14d which is separated here from the laser medium 1 by a small gap in order to ensure the total reflection of the laser beam 4 in the laser medium in the course of the zigzag-shaped profile thereof.

Such a pump device is known from WO 2014/019003 A1 which is cited in the introduction to the description. It is advantageous to use a pump device with an optical system which has a cylinder mirror or a cylinder lens, the cylinder axis being oriented in the direction of the fast axis. Pump devices which are embodied in some other way could also be used to pump the laser medium 1.

The first side face 6 of the laser medium 1 through which the pump radiation 5 enters is parallel to the z axis and parallel to the y axis, that is to say parallel to the y-z plane.

In particular, the z axis forms the longitudinal axis of the laser medium 1.

The zig-zag-shaped profile of the laser beam 4 through the laser medium 1 is located in a plane which is parallel to the x axis and parallel to the z axis, that is to say parallel to the x-z plane.

Viewed in the direction of the x axis, that is to say with respect to the projection into the y-z plane, the laser beam 4 (=the laser mode) runs through the laser medium 1 in the direction of the z axis (=parallel to the z axis).

The x, y and z axes form a Cartesian coordinate system.

The laser medium 1 is cooled by a heat sink 22. The cooling takes place at a second side face 23 of the laser medium 1 which is parallel to the first side face 6, that is to say also parallel to the y-z plane. For this purpose, the second side face 23 is connected to the heat sink 22. The connection to the heat sink 22 is made via a cooling strip 24. There is preferably also an optical coating (not illustrated in the figures) on the second side face 23 of the laser medium 1. This coating is applied to the second side face 23 in order to ensure that, on the one hand, the total reflection of the laser beam which is guided in a zigzag shape is maintained and, on the other hand, the remaining pump radiation is reflected back into the crystal and does not impinge on the cooling strip 24. Such coatings are perfectly customary in laterally pumped zig-zag lasers. Furthermore, a connecting material (in particular a bonding agent or a solder) is advantageously provided for attaching the cooling strip 24 to the second side face 23 of the laser medium 1 or the optical coating applied thereto. The cooling strip 24 is composed here from a material which differs from the laser medium 1 and the heat sink 22 and rests via the connecting material on the second side face 23 of the laser medium 1 or the optical coating applied thereto. The cooling strip 24 could also be formed by a strip-shaped elevated portion of the heat sink 22 and would therefore be composed of the same material from which the rest of the heat sink 22 is composed. In this case, the cooling strip could also rest directly, or via a connecting material (in particular an adhesive or a solder) on the laser medium 1 or the optical coating applied thereto.

The thermal conductivity of the material of the cooling strip 24 is advantageously larger than 5 W/mK. On the other side of the region over which the cooling strip 24 extends, the second side face 23 is separated from the heat sink 22 by an air gap 25. A fixed material, which has thermal conductivity which is at least half as large as the thermal conductivity of the material of the cooling strip 24 could also be provided, at least partially, in this region instead of the air gap.

The thermal conductivity of the material which is present on the other side of the cooling strip 24 between the laser medium 1 and the heat sink 22 (and which can be, in particular, gaseous or solid) is preferably below 2 W/mK, particularly preferably below 1 W/mK.

The second side face 23 is located opposite the first side face 6, i.e. when viewed in the direction of the x axis the side faces 6, 23 overlap at least partially, preferably at least mostly (i.e. over more than 50% of their areas).

It is preferred that the first and second side faces 6, 23 extend over the same region with respect to the direction of the y axis.

The laser medium 1 preferably has a prismatic shape. The base face 37 and cover face 38 advantageously lie parallel to the x-z plane here, said base and cover faces 37, 38 being a straight prism, in particular a parallelepiped.

For example, the extent of the laser medium 1 with respect to the y direction is 5 mm to 15 mm, in the exemplary embodiment 8 mm. The extent of the laser medium in the x direction is, for example, 2 mm to 8 mm, in the exemplary embodiment 4 mm. The extent of the laser medium in the z direction is, for example, 20 mm to 80 mm, in the exemplary embodiment approximately 40 mm.

The cooling strip 24 is formed, for example, by a graphite film, e.g. 125 μm or 250 μm in thickness. The conduction of heat of such a graphite film can be, for example, 16 W/mK. The connection of the graphite film to the second side face 23 of the laser medium 1 and the heat sink 22 can take place, for example, by bonding and/or clamping. In another possible embodiment, the cooling strip 24 can be formed by an indium strip. Such an indium strip can be soldered, for example, to the second side face 23 of the laser medium 1 and the heat sink 22. Indium or AgSn (e.g. 96.5%, Sn and 3.5% Ag) or also the relatively hard AuSn are suitable as a solder.

The heat sink 22 can be composed, for example, from copper tungsten which has a similar coefficient of thermal expansion to Nd:YAG, e.g. copper tungsten with 85% W and 15% Cu.

Other materials are also conceivable and possible for the cooling strip 24 and/or the heat sink 22. For example, the cooling strip 24 could also be formed by a strip-shaped elevated portion of the heat sink 22, which elevated portion is in thermal contact with the second side face 23 of the laser medium 1, for example by pressing or soldering it onto the second side face 23.

The cooling strip 24 extends in the y direction over a section 26 of the y axis, which section 26 is referred to as the y cooling region in this document. In addition, the cooling strip 24 extends with respect to the z direction over a section 27 of the z axis, which section 27 is referred to as the z cooling region in this document.

In this document, a section 28 of the y axis over which 80% of the total power of the pump radiation absorbed by the laser medium 1 is absorbed is referred to as the y pump region. The y pump region 28 is selected here in such a way that the intensity of the pump radiation 5 at the two ends of the y pump region is of equal magnitude. In addition, in this document the section 29 of the z axis over which 80% of the total power of the pump radiation 5 absorbed by the laser medium 1 is absorbed is referred to as the z pump region. The z pump region 29 is selected here in such a way that at its two ends the intensity of the pump radiation is of equal magnitude. The y and z pump regions are indicated in FIG. 6 by an area which is represented by hatching. The part of the volume of the laser medium 1 which forms a cube, of which opposite side faces of those parts of the first and second side faces 6, 23 of the laser medium 1, covered by the area illustrated by hatching in FIG. 6, are formed, is referred to in this document as “pumped volume” of the laser medium 1. In the pumped volume of the laser medium 1 the majority, specifically 80% of the absorption of the power of the pump radiation, therefore takes place, with the result that the majority of the heat introduced by the pump radiation is also correspondingly introduced into the pumped volume of the laser medium 1. Correspondingly, the excitations of the laser medium 1 mainly, specifically 80% thereof, occur at the inversion level in the pumped volume. The pumped volume can therefore be determined from the inversion density.

The inversion density can be measured, in particular, by fluorescence images. For example, for this purpose the heat sink 22 can be removed and the fluorescence images can be captured through the second side face 23, wherein the pump radiation 5 is screened by means of a filter.

The pumped volume extends therefore in the direction of the x axis over the extent of the laser medium 1. In the direction of the z axis, the extent of the pumped volume is preferably more than 50% of the extent of the laser medium 1 in the direction of the z axis and less than 90% of the extent of the laser medium 1 in the direction of the z axis.

In the direction of the y axis, the extent of the pumped volume is preferably in the range from a third to two thirds of the extent of the laser medium 1 in the direction of the y axis.

The pumped volume is preferably in a central region of the laser medium 1 with respect to the direction of the z axis and with respect to the direction of the y axis.

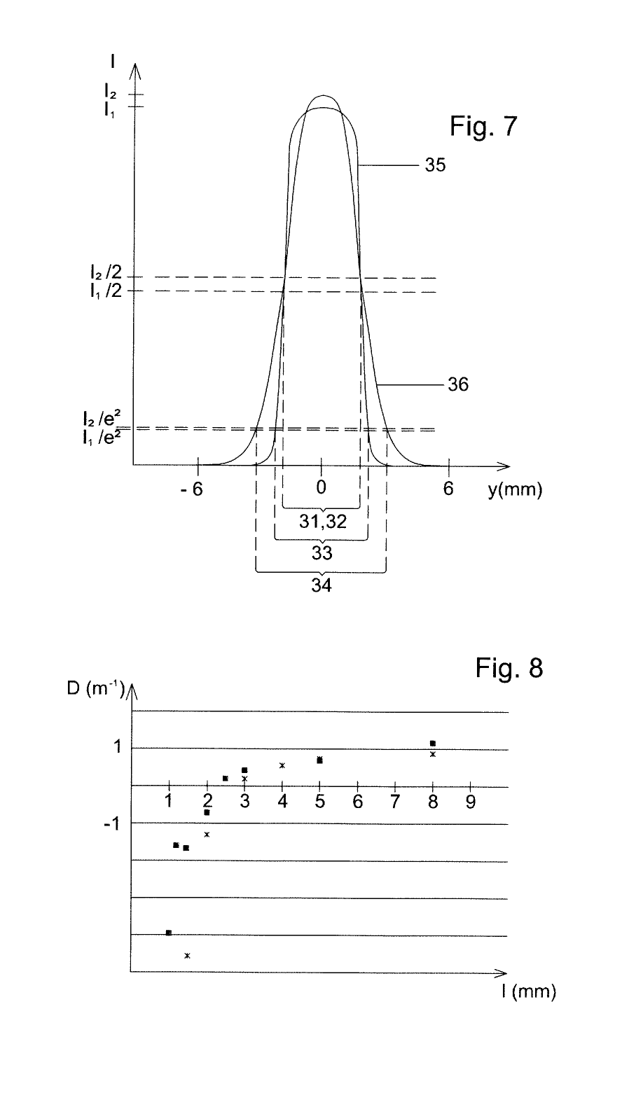

The pump radiation 5 which is incident on the first side face 6 has an intensity distribution which is significantly closer to a rectangular profile compared to a beam with a Gaussian distribution. In FIG. 7, the distribution 35 of the intensity I of the pump radiation is illustrated with respect to the y axis. The maximum value of the intensity is I1. The zero point of the y axis is positioned at the point of the maximum value of the intensity. For the purpose of comparison, the distribution 36 of the intensity of a virtual beam with the same wavelength is shown with a Gaussian profile which has the same half value width, wherein the maximum value of the intensity is at the zero point of the y axis. The maximum value of the intensity is I2 here. The radiation energy of the virtual beam, that is to say the area enclosed by the distribution 36, is equal to the radiation energy of the pump radiation here.

The section 31 of the y axis over which the intensity of the pump radiation 5 is more than half the maximum intensity of the pump radiation at the first side face of the laser medium 1 is denoted in this document as the y half value region of the pump radiation. The length of this section 31 therefore corresponds to the half value width of the intensity profile of the pump radiation 5. The y half value range of the virtual beam is defined analogously, and the corresponding section of the y axis, which corresponds to the section 31, is denoted by the reference symbol 32 in FIG. 7.

FIG. 7 also shows the points on the y axis at which the intensity of the pump radiation 5 or of the virtual beam has dropped to a value which is 1/e² (that is to say approximately 13.5%) of the maximum value. The y−1/e² region of the pump radiation 5 correspondingly denotes the section 33 of the y axis over which the intensity of the pump radiation at the first side face 6 of the laser medium 1 has a value which is more than the maximum intensity of the pump radiation at the first side face 6 of the laser medium 1 divided by e². The y−1/e² region of the virtual beam is defined analogously, and the corresponding section of the y axis is denoted by the reference symbol 34 in FIG. 7.

The difference between the length of the y−1/e²region 33 of the pump radiation 5 and the length of the y half value region 31 of the pump radiation 5 can be read off at approximately 0.85 mm from FIG. 7 for the present example. The difference between the length of the y−1/e² region 34 and the length of the y half value region 32 of the virtual beam with the Gaussian profile can be read off at approximately 2.6 mm from FIG. 7. This difference is therefore less than half as large for the pump radiation 5 as for the virtual beam with the Gaussian profile.

The length of the y−1/e² region 33 of the pump radiation 5 is also shorter than the length of the first side face 6 of the laser medium 1 in the direction of the y axis, wherein the first side face 6 of the laser medium 1 extends beyond the y−1/e² region of the pump radiation in both directions of the y axis, preferably to the same extent. The length of the y−1/e² region 33 of the pump radiation 5 is, for example, 4 mm, while the length of the first side face 6 of the laser medium 1 in the direction of the y axis is 8 mm.

As is apparent from FIG. 6, the length of the y cooling region is shorter than the length of the laser medium 1 in the direction of the y axis. The length of the y cooling region is, however, also shorter than the length of the y pump region, as is explained below.

In FIG. 8, measured values which reflect the dependence of the refractive index D of the formed thermal lens as a function of the length I of the y cooling region are plotted as black squares. If the y cooling region extends over the entire y extent of the laser medium 1, the refractive index of the thermal lens is over 1 m-1 with respect to the y direction with the operating parameters used in the trial arrangement. When the extent of the y cooling region is reduced, the refractive index is firstly reduced slowly, wherein given a length I of the y cooling region of 3 mm, which is therefore shorter than the length of the y pump region of 4 mm, said refractive index has dropped to a value of barely 0.5 m-1. Given a further reduction in the length I of the y cooling region, the refractive index of the thermal lens is reduced further, and given a length I of the y cooling region of 2 mm it is already negative. Given a further reduction in the length I of the y cooling region, the thermal lens becomes highly negative, e.g. with a refractive force of −3 m-1 given a length of they cooling region of 1 mm.

In the diagram in FIG. 8, values of a calculation which reflect well the measured values which are obtained are plotted as stars.

The formation of a negative thermal lens with small dimensions of the y cooling region can be explained by the formation of a central depression in the temperature profile over the y pump region.

By means of a suitable selection of the size of they cooling region it is therefore possible to achieve a thermal lens which disappears or virtually disappears with respect to the y direction. The length of the y cooling region is chosen in this respect to be shorter than 70% and larger than 50% of the length L of they pump region.

The y pump region extends beyond the y cooling region in both directions of the y axis, preferably to the same extent, i.e. the y cooling region is located centrally in the y pump region with respect to the y direction.

The length of the z cooling region 27 of the laser medium 1 is, in contrast, advantageously larger than the length of the z pump region 29 of the laser medium 1. The extent of the z cooling region in both directions of the z axis beyond the z pump region is advantageously selected to be of such a size that inhomogenities of the temperature distribution in the pumped volume of the laser medium 1 at the ends of its extent in the direction of the z axis are kept as small as possible.

The beam profile of the laser mode which is formed is advantageously adapted as much as possible to the profile of the excitation by means of the pump radiation 5 with respect to the y direction, in particular through the use of a suitable gradient mirror. The beam profile of the laser beam 4 with respect to the y direction is therefore to have an intensity distribution which is significantly shifted in the direction of a rectangular profile compared to a Gaussian profile.

A y half value region and a y−1/e² region of the laser beam 4 can be defined in the laser medium 1 and on exiting the laser medium in a way which is analogous to that for the pump radiation 5. The y−1/e² region of the laser beam therefore constitutes a section of the y axis over which the intensity of the laser beam 4 has a value which is more than the maximum intensity of the laser beam 4 divided by e². The y half value region of the laser beam 4 denotes a section of the y axis over which the intensity of the laser beam 4 has a value which is more than half the maximum intensity of the laser beam 4.

In particular, the laser beam 4 is embodied in such a way that the difference between the length of the y−1/e² region of the laser beam and the length of the y half value region of the laser beam is less than half as large as the difference between the length of the y−1/e² region and the length of the y half value region of a virtual beam which has the same wavelength and a Gaussian profile and the length of the half value region of which is equal to the length of the y half value region of the laser beam 4 and the radiation energy of which is equal to the radiation energy of the laser beam 4.

By the invention it is possible to make available, for example, an in particular pulsed, Nd:YAG laser with an average power of >2 W and a beam divergence of <250 μrad (half angle divergence) in both transverse directions and a M [symbol] 2 of <5 or else <3 without symmetry-compensating and astigmatism-compensating optical systems having to be installed in the external laser beam 4a or else in the resonator.

### KEY TO REFERENCE SYMBOLS

1 Amplifying laser medium

2 Entry face

3 Exit face

4,4a Laser beam

5 Pump radiation

6 First side face

7 End mirror

8 Output coupling mirror

9 Inverting prism

10 Polarizer

11 Pockels cell

12 λ/4 plate

13 Radiation source

14 Optical system

14a Entry face

14b Cylinder face

14c Side face

14d Exit face

15 Bars

16 Laser diode

17 Laser beam

18 Carrier

20 Carrier

21 Heat sink

22 Heat sink

23 Second side face

24 Cooling strip

25 Air gap

26 y cooling region

27 z cooling region

28 y pump region

29 z pump region

31 y half value region

32 y half value region

33 y−1/e² region

34 y−1/e² region

35 Distribution

36 Distribution

37 Base face

38 Cover face

1. A solid-state laser comprising an amplifying laser medium for producing a laser beam and a pump device which has at least one laser diode and by which pump radiation is produced, said pump radiation impinges on a first side face of the laser medium, said first side face is parallel to a z axis and parallel to a y axis which is at a right angle to the z axis,
wherein, viewed in a direction of an x axis which is at a right angle to the z axis and at a right angle to the y axis, the laser beam runs through the laser medium parallel to the z axis,
a heat sink to cool the laser medium is located on a second side face of the laser medium which is parallel to the z axis and parallel to the y axis and opposite the first side face, said laser medium being thermally connected to said heat sink,
wherein a length of a y cooling region is shorter than a length of the second side face of the laser medium in a direction of the y axis, wherein the y cooling region of the laser medium denotes a section of the y axis over which a cooling strip extends, said cooling strip thermally connects the laser medium to the heat sink at the second side face,
wherein a length of a y−1/e² region of the pump radiation is shorter than a length of the first side face of the laser medium in the direction of the y axis, and the first side face of the laser medium extends beyond the y−1/e² region of the pump radiation in both directions of the y axis,
wherein the y−1/e² region of the pump radiation denotes a section of the y axis over which an intensity of the pump radiation at the first side face of the laser medium has a value which is more than a maximum intensity of the pump radiation at the first side face of the laser medium divided by e², and
the length of the y cooling region of the laser medium is shorter than 70% and larger than 50% of a length of a y pump region of the laser medium, and the y pump region exceeds the y cooling region in both directions of the y axis, wherein the y pump region denotes a section of the y axis over which 80% of a total power of the pump radiation absorbed by the laser medium is absorbed, and at the two ends of which an intensity of the pump radiation is of equal magnitude.

2. The solid-state laser as claimed in claim 1, wherein a difference between the length of the y−1/e² region of the pump radiation and a length of a y half value region of the pump radiation is less than half as large as a difference between a length of a y−1/e² region and a length of a y half value region of a virtual beam with a same wavelength, said virtual beam having a Gaussian profile and the length of the y half value region of which is equal to the length of the y half value region of the pump radiation and radiation energy of which is equal to the radiation energy of the pump radiation,
wherein the y half value region of the pump radiation denotes a section of a y axis over which the intensity of the pump radiation at the first side face of the laser medium has a value which is more than half a maximum intensity of the pump radiation at the first side face of the laser medium, the y−1/e² region of the virtual beam denotes a section of they axis over which an intensity of the virtual beam at the first side face of the laser medium has a value which is more than a maximum intensity of the virtual beam at the first side face of the laser medium divided by e², and the y half value region of the virtual beam denotes a section of the y axis over which the intensity of the virtual beam at the first side face of the laser medium has a value which is more than half the maximum intensity of the virtual beam at the first side face of the laser medium.

3. The solid-state laser as claimed in claim 1, wherein a z cooling region of the laser medium is larger than a z pump region of the laser medium, and
the z cooling region of the laser medium denotes a section of the z axis over which the cooling strip by which the laser medium is thermally connected to the heat sink at the second side face extends, and
the z pump region denotes a section of the z axis over which 80% of a total power of the pump radiation absorbed by the laser medium is absorbed and at the two ends of which the intensity of the pump radiation is of equal magnitude.

4. The solid-state laser as claimed in claim 1, wherein the cooling strip has thermal conductivity of more than 5 W/mK.

5. The solid-state laser as claimed in claim 1, wherein apart from a region over which the cooling strip extends, an air gap is located between the second side face of the laser medium and the heat sink.

6. The solid-state laser as claimed in claim 1, wherein the laser medium has a prismatic shape, edges which bound an extent of the first side face of the laser medium in the direction of the y axis on both sides and edges which bound an extent of the second side face of the laser medium in the direction of the y axis on both sides are parallel to the z axis.

7. The solid-state laser as claimed in claim 1, wherein the laser medium is arranged in a resonator.

8. The solid-state laser as claimed in claim 1, wherein the laser beam penetrates the laser medium running in a zig-zag shape and at the same time is located in a plane which is at a right angle to the y axis.

9. The solid-state laser as claimed in claim 1, wherein the laser beam has, in at least one of the laser medium or at an exit from the laser medium, a beam profile in which a difference between the length of a y−1/e² region of the laser beam and a length of a y half value region of the laser beam is less than half as large as a difference between the length of a y−1/e² region and a length of a y half value region of a virtual beam with the same wavelength, said beam having a Gaussian profile and of which beam the length of a y half value region is equal to the length of the y half value region of the laser beam and whose radiation energy is equal to the radiation energy of the laser beam, wherein the y−1/e² region of the laser beam denotes a section of the y axis over which the intensity of the laser beam has a value which is more than the maximum intensity of the laser beam divided by e²,
wherein the y half value region of the laser beam denotes a section of the y axis over which the intensity of the laser beam has a value which is more than half the maximum intensity of the laser beam,
wherein the y−1/e² region of the virtual beam denotes a section of the y axis over which the intensity of the virtual beam has a value which is more than a maximum intensity of the virtual beam divided by e²,
wherein the y half value region of the virtual beam denotes a section of the y axis over which the intensity of the virtual beam has a value which is more than half the maximum intensity of the virtual beam.

10. The solid-state laser as claimed in claim 1, wherein an absolute value of a refractive index of a thermal lens, formed by the laser medium during operation of the solid state laser, is less than 0.5 m-1 with respect to the y axis.
